(19) United States
(12) Patent Application Publication
(10) Pub. No.: US 2010/0075269 A1
(43) Pub. Date: Mar. 25, 2010

(54) ACCESSORY MOUNTING CLIP FOR ORTHODONTIC ALIGNER TRAYS

(75) Inventors: Mark D. Mutschler, West Linn, OR (US); Aaron D. Costello, Chula Vista, CA (US); Douglas Daniel Crimaldi, San Marcos, CA (US)

Correspondence Address: FULWIDER PATTON LLP, HOWARD HUGHES CENTER, 6060 CENTER DRIVE, TENTH FLOOR, LOS ANGELES, CA, 90045, US

(73) Assignee: Ortho Organizers, Inc., Carlsbad, CA (US)

(21) Appl. No.: 12/235,485

(22) Filed: Sep. 22, 2008

(51) Int. Cl. A61C 7/14

(52) U.S. Cl. 433/10

(57) ABSTRACT

The accessory mounting clip includes one or more clip members and one or more mounting portion on the one or more clip members that permits attachment of orthodontic appliances to an orthodontic aligner tray, allowing such aligner trays to be used for correction of moderate to severe orthodontic malocclusions.

### BACKGROUND OF THE INVENTION

This invention relates generally to an orthodontic appliance, and more particularly concerns an accessory mounting clip for attaching an orthodontic appliance to an orthodontic aligner tray for correction of moderate to severe orthodontic malocclusions.

A recent development in the art and science of orthodontia as a way of straightening teeth without using traditional braces has been the development of digitally custom fabricated transparent plastic aligner trays to gradually move teeth to desired positions and orientations, typically through the fabrication of a series of such aligner trays for a patient as the treatment progresses. This type of orthodontic treatment is cosmetically appealing, in that the aligner trays are unobtrusive and typically largely undetectable, are typically more comfortable than traditional braces, and are readily removable for meals. Such aligner trays also can help to avoid side effects on the gums, supporting tissues, and directly on teeth, such as demineralization or tooth decay, for example, that are common with fixed orthodontic appliances. Aligner trays can also be readily removed for cleaning and checking of a patient's teeth. The aligner trays are increasing in popularity due to their aesthetic nature and their ease of use.

However, aligner trays commonly provide substantially less force for correction of orthodontic problems, compared to the greater forces that fixed appliances can apply. The aligner trays can not currently interface with the appliances necessary for correcting moderate to severe orthodontic malocclusions. This limits the aligner trays to treatment of only mild malocclusions. It would therefore be desirable to provide apparatus configured to be used with such aligner trays to allow greater corrective forces to be applied for correction of orthodontic problems, and particularly for the types of orthodontic problems that require strong corrective force, such as moderate to severe orthodontic malocclusions. The present invention meets these and other needs.

### SUMMARY OF THE INVENTION

Briefly, and in general terms, the present invention provides for apparatus for attaching orthodontic appliances to an orthodontic aligner tray allowing orthodontia patients to receive more complete treatment by permitting such aligner trays to interface with other orthodontic appliances, and allowing such aligner trays to be used for correction of moderate to severe orthodontic malocclusions.

The present invention accordingly provides for a mounting clip for attaching an orthodontic appliance to an orthodontic aligner tray for correction of moderate to severe orthodontic malocclusions, including one or more clip members configured to be removably attached to at least one of the lingual, occlusal, and labial sides of the aligner tray; and a mounting portion on the one or more clip members configured to secure an orthodontic appliance to the one or more clip members.

In one presently preferred embodiment, the one or more clip members have a first lingual portion with a first retention member configured to engage the lingual edge of the aligner tray, a second labial portion with a second retention member configured to engage the labial edge of the aligner tray, and an occlusal portion connecting the first lingual portion and the second labial portion. In a broad aspect, the one or more clip members may include first and second parts that are configured to be detachably connected together. The first part of the one or more clip members can be attached to the aligner tray, and the second part of the one or more clip members can be attached to the orthodontic appliance, for example.

In one presently preferred aspect, the first retention member of the one or more clip members includes a first pair of first and second shafts connected by an occlusal spring clip, and the second retention member of the one or more clip members includes a second pair of first and second shafts connected by an occlusal spring clip, the first pair of first and second shafts being connected to the second pair of first and second shafts on at least one of the lingual and labial sides by a telescoping member which can be crushed to fix the position of the first and second pairs of first and second shafts relative to each other. The first and second shafts preferably terminate in a configuration that fits over the edge of the aligner tray to retain the mounting clip on the aligner tray. In one variation, the first and second shafts of the first and second pairs of first and second shafts each terminate in a ball end configured to fit over the edge of the aligner tray. In another variation, the first and second shafts of the first and second pairs of first and second shafts each terminate in a hook end configured to fit over the edge of the aligner tray. In another variation, the first and second shafts of the first and second pairs of first and second shafts each terminate in a D-notch end configured to fit over the edge of the aligner tray. The configuration of the termination of the first and second shafts can also be different from each other, as desired. In another aspect, the telescoping member includes a tubular sleeve member connected to one of the first and second shafts and a rod member connected to the other of the first and second shafts, the rod member being slidably disposed in the tubular sleeve member. An additional mounting attachment allowing the connection of one or more additional orthodontic connectors to the mounting clip, such as a flat mounting plate or a mounting wire may additionally be secured to the tubular sleeve member, such as by soldering or welding, for example.

In another presently preferred embodiment, the one or more clip members include a U-shaped clip configured to be attached over the occlusal side of the aligner tray, the U-shaped clip having first and second gingival mesial-distal cylindrical edges, the U-shaped clip having first and second gingival mesial-distal cylindrical edges and providing a mechanical retention configuration permitting attachment of an orthodontic connector to the mounting clip. In a broad aspect, the U-shaped clip includes one or more mounting surface areas on a lingual side of the clip for mounting of lingual attachments, although the U-shaped clip may also include one or more mounting surface areas on a labial side for mounting of labial attachments. In one presently preferred aspect, the U-shaped clip has an approximate midline and a longitudinal axis, and the U-shaped clip comprises first and second halves slidably joined together along the approximate midline and the longitudinal axis, the first half having a male end and the second half having a female longitudinal slot, the male end configured to be received in the female longitudinal slot, and the distance between the lingual and labial sides of the U-shaped clip being adjustable by sliding of the first and second halves with respect to each other and crimping the female longitudinal slot over the male end to lock the two halves of the U-shaped clip in place. In another presently preferred aspect, the U-shaped clip has an approximate midline and a longitudinal axis, and the U-shaped clip comprises first and second halves with cooperating, interlocking indentations configured to be adjustable by sliding of the first and second halves with respect to each other and crimping the cooperating, interlocking indentations to lock the two halves of the U-shaped clip in place.

In another presently preferred embodiment, the one or more clip members include first and second substantially parallel and spaced-apart elongated members each having a first end and a second end and a middle portion therebetween, with a stop member at the first end, the first and second elongated members being slidably connected together by one or more connector members having opposing first and second tubular ends configured to slidably receive the first and second elongated members, respectively, with the first and second ends of the elongated members extending at substantially a right angle in the same direction from the middle portion of the elongated members. In a broad aspect, the elongated members may form a U-shaped clip. In a presently preferred aspect, the one or more connector members include a middle portion formed to have a U-shaped bend configured to be crushed to adjust the distance between the first and second elongated members. The second ends of the elongated members may be bent to form a hook. In addition, the mounting portion preferably includes at least one flat mounting plate connected between the first and second elongated members.

In another presently preferred embodiment, the one or more clip members are formed from one or more wires to form distal and mesial spring clips joined by middle connector portions. The one or more wires form a first open loop at a distal-lingual inter-tooth location of the aligner tray, continue from the first open loop in a distal occlusal surface portion across the occlusal side of the aligner tray to a labial side of the aligner tray, forming a second open loop at a distal-labial inter-tooth location of the aligner tray. The first and second open loops and the distal occlusal surface portion form the distal spring clip portion, with the first and second open loops configured to grip the lingual and labial edges of the aligner tray. The one or more wires continue from the second open loop, forming a labial middle connecting portion, and continue mesially along the labial side of the aligner tray, forming a third open loop at a mesial-labial inter-tooth location of the aligner tray. The one or more wires continue from the third open loop in a mesial occlusal surface portion across the occlusal side of the aligner tray to the lingual side of the aligner tray, forming a fourth open loop at a mesial-lingual inter-tooth location of the aligner tray. The third and fourth open loops and the mesial occlusal surface portion form the mesial spring clip portion, with the third and fourth open loops configured to grip the lingual and labial edges of the aligner tray.

In another presently preferred embodiment, the one or more clip members are formed as a sheet metal clip formed from flat sheet metal in a flat pattern, the sheet metal clip having a rectangular main body portion having a narrow gingival side, a distal wide side, and a mesial wide side, a gingival hook portion extending from the narrow gingival side, two gingival side arm portions adjacent to the gingival hook portion extending outwardly distally and mesially from the gingival side of the main body portion, and two occlusal side arm portions extending outwardly distally and mesially from the occlusal narrow end of the main body portion. The one or more clip members typically include a distal pair of sheet metal clips located at a distal inter-tooth location of the aligner tray, and a mesial pair of sheet metal clips located at a mesial inter-tooth location of the aligner tray. The distal pair of sheet metal clips include a distal labial sheet metal clip configured to be positioned on the labial side of the aligner, and a distal lingual sheet metal clip configured to be positioned on the lingual side of the aligner. Each of the distal pair of sheet metal clips is oriented with the gingival hook portion toward the gingival edge of the aligner tray, with a distal pair of the occlusal and gingival side arm portions of each of the distal pair of sheet metal clips retaining a distal occlusal wire configured to cross the occlusal side of the aligner tray and connecting the distal pair of sheet metal clips, and with the gingival hook portions bent to hook onto the gingival edge of the aligner tray. The mesial pair of sheet metal clips includes a mesial labial sheet metal clip configured to be positioned on the labial side of the aligner, and a mesial lingual sheet metal clip configured to be positioned on the lingual side of the aligner. Each of the mesial pair of sheet metal clips is oriented with the gingival hook portion toward the gingival edge of the aligner tray, with a mesial pair of the occlusal and gingival side arm portions of each of the mesial pair of sheet metal clips retaining a mesial occlusal wire configured to cross the occlusal side of the aligner tray and connecting the mesial pair of sheet metal clips, and with the gingival hook portions bent to hook onto the gingival edge of the aligner tray. A pair of labial and lingual middle connecting wires are connected between the occlusal and gingival mesial side arm portions of the distal pair of sheet metal clips and the occlusal and gingival distal side arm portions of the mesial pair of sheet metal clips.

In another presently preferred aspect, the mounting portion can include a rectangular tubular member having a slotted portion configured to receive a spring clip having a post for mounting of an orthodontic appliance. A forked member, having substantially parallel first and second arms extending from a first end of the forked member, and a center post extending from a second end of the forked member, can be mounted to a side portion of the rectangular tubular member. Alternatively, another type of forked member, having substantially parallel first and second arms and a third central arm disposed between the first and second arms, the first, second and third central arms extending from a first end of the forked member, can be mounted to a side portion of the rectangular tubular member.

In another presently preferred embodiment, the one or more clip members further include a plug member attached to the one or more clip members, and the mounting portion includes a spring clip having radially inwardly directed gripping teeth configured to grip the plug member.

In another preferred embodiment, in which the aligner tray includes a side portion with a protrusion, the one or more clip members include a clamping member with a living hinge at a first portion of the clamping member and a pair of removably clasping ends at an opposing second portion of the clamping member, the clamping member having a radially inward surface including a plurality of prongs directed radially inwardly for gripping the protrusion of the aligner tray. In another aspect, the clamping member may include a tube member attached to the clamping member between the first portion and the opposing second portion. The one or more clip members may alternatively be formed as a spring clip from an elongated member having first and second end portions and having spring properties, the elongated member being formed in a loop such that the first and second end portions overlap, and the spring clip has a radially inward surface including a plurality of prongs directed radially inwardly for gripping the protrusion of the aligner tray.

By facilitating the use of the above mentioned orthodontic appliances with orthodontic aligner trays, the moderate to severe cases can be treated with orthodontic aligner trays. Also all patients using these aligner trays could receive more complete treatment with the ability to interface with other orthodontic appliances.

Other features and advantages of the present invention will become more apparent from the following detailed description of the preferred embodiments in conjunction with the accompanying drawings, which illustrate, by way of example, the principles of the invention.

### BRIEF DESCRIPTION OF THE DRAWINGS

FIG. 1 is a perspective view of an embodiment of a “single sided” mounting clip according to the present invention shown in a bent configuration and engaging a portion of an aligner tray.

FIG. 2 is a perspective view of the mounting clip of FIG. 1 prior to bending to engage an aligner tray.

FIG. 3 is a perspective view of the mounting clip of FIG. 1 shown in a bent configuration for engaging an aligner tray, and showing an orthodontic appliance mounted to the mounting clip.

FIG. 4 is a perspective view of an embodiment of a “double sided” mounting clip according to the present invention shown in a bent configuration and engaging a portion of an aligner tray.

FIG. 5a is a perspective view of an embodiment of a mounting clip according to the present invention including a single tubular mounting portion and a clamping member with a living hinge and radially inwardly directed prongs for engaging a protrusion of an aligner tray.

FIG. 5b is a sectional view taken along line 5b-5b of FIG. 5a.

FIG. 6 is a perspective view of an embodiment of a mounting clip according to the present invention including two tubular mounting portions and a clamping member with a living hinge and radially inwardly directed prongs for engaging a protrusion of an aligner tray.

FIG. 7 is a plan view of an embodiment of a mounting clip according to the present invention including a spring clip member and radially inwardly directed prongs for engaging a protrusion of an aligner tray.

FIG. 8 is a perspective view of an embodiment of a mounting clip according to the present invention including parallel spaced apart first and second elongated members and one or more connector members slidably connecting the first and second elongated members.

FIG. 9 is a perspective view of the mounting clip of FIG. 8 shown in a bent configuration engaging an aligner tray.

FIG. 10 is another perspective view of the mounting clip of FIG. 8 shown in a bent configuration engaging an aligner tray.

FIG. 11 is a perspective view of another embodiment of a mounting clip according to the present invention including an integral one-piece U-shaped clip with cylindrical edges for engaging an aligner tray.

FIG. 12 is a cross-sectional view of another embodiment of a mounting clip according to the present invention including a two-piece slidably adjustable U-shaped clip similar to the mounting clip of FIG. 11, with cylindrical edges for engaging an aligner tray.

FIG. 13 is a cross-sectional view of the mounting clip of FIG. 12, showing the two-piece slidably adjusted so that the cylindrical edges are spaced apart by a dimension “A” for engaging an aligner tray.

FIG. 14 is a cross-sectional view of another embodiment of a mounting clip according to the present invention including a two-piece slidably adjustable U-shaped clip similar to the mounting clip of FIG. 11, with interlocking grooves and ridges and cylindrical edges for engaging an aligner tray.

FIG. 15 is a perspective view of another embodiment of a first portion of a mounting clip according to the present invention including a pair of retention members slidably connected by a telescoping member for engaging an edge of an aligner tray.

FIG. 16 is a perspective view of the first and second portions of the mounting clip of FIG. 15 including occlusal connecting portions and a mounting portion, shown in a bent configuration engaging an aligner tray.

FIG. 17 is a perspective view of another embodiment of the second portion of FIG. 16 including the mounting portion over the telescoping member.

FIG. 18 is a schematic diagram of another embodiment of a mounting clip according to the present invention including two pairs of clip members formed from sheet metal and including portions bent for retaining middle wire connectors and occlusal wire connectors for connected between pairs of the clip members, and the clip members including portions shown in a bent configuration for engaging an aligner tray.

FIG. 19 is a plan view of a sheet metal clip member of FIG. 18, showing directions for bending the portions of the clip member.

FIG. 20 is a plan view of a portion of a stamping pattern for forming a plurality of the sheet metal clip members of FIGS. 18 and 19.

FIG. 21 is an exploded perspective view of a mounting portion for a clip member formed as a rectangular tubular member receiving a removable spring clip for mounting an orthodontic bracket screw or clamp mounting device.

FIG. 22 is a perspective view of tubular mounting portions and a forked member mounting portion for a mounting clip according to the present invention.

FIG. 23 is a plan view of an alternative version of a forked member mounting portion for a mounting clip according to the present invention.

FIG. 24 is a perspective view of another embodiment of a mounting clip according to the present invention, including adjustable distal and mesial wire spring clip portions, showing a shortened adjustment of the distal and mesial wire spring clip portions.

FIG. 25 is a perspective view of the mounting clip of FIG. 24, showing a lengthened adjustment of the distal and mesial wire spring clip portions.

FIG. 26 is a perspective view of a coupling member used to adjustably connect the mesial and distal occlusal surface wire portions with the lingual and labial wire portions.

FIG. 27 is a perspective view of another embodiment of a mounting clip according to the present invention, including occlusal connecting and mounting clip members connected by telescoping members.

FIG. 28 is an enlarged view of a telescoping member of the mounting clip of FIG. 27.

FIG. 29 is a perspective view of a variation of the second portion of FIG. 16, including an alternative mounting attachment and notched ends of the first and second shafts of a retention member.

### DETAILED DESCRIPTION OF THE PREFERRED EMBODIMENTS

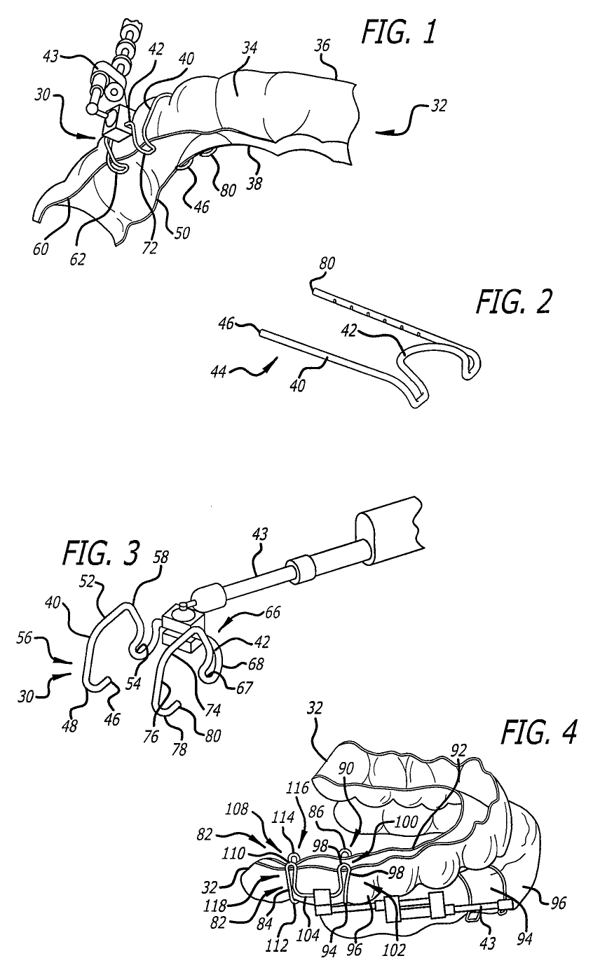

As is illustrated in the drawings, which are provided for purposes of illustration, and not by way of limitation, in a first presently preferred embodiment, the present invention provides for a mounting clip 30 for attaching an orthodontic appliance to an orthodontic aligner tray 32, illustrated in FIGS. 1 and 4, for correction of moderate to severe orthodontic malocclusions. The aligner tray typically has a lingual side 34, an occlusal side 36, and a labial side 38, and the mounting clip includes at least one clip member 40 configured to removably connect the mounting clip to at least one of the lingual, occlusal, and labial sides of the aligner tray. The mounting clip includes one or more mounting portions 42 on the one or more clip members configured to secure an orthodontic appliance 43 to the one or more clip members.

As is illustrated in FIGS. 1-3, in the first embodiment, the one or more clip members are formed from a single wire 44 having a first end 46 that is typically bent to form approximately a right angle portion 48 configured to engage a first side lower edge 50 of the aligner tray, and extending toward the occlusal side of the aligner tray and forming a first occlusal portion 52 configured to extend across the occlusal side of the aligner tray, to a first open loop 54 at a first end 56. The first open loop is typically bent to form approximately a right angle 58 extending away from the occlusal side of the aligner tray, toward the opposing second side lower edge 60 of the aligner tray, and the first open loop is then typically bent to form approximately a right angle portion 62 configured to engage the second side lower edge of the aligner tray. The wire extends toward the occlusal side and then away from the occlusal side to form a u-shaped connecting and mounting surface portion 66, and continues, forming a second open loop 67 typically bent to form approximately a right angle 68 extending away from the occlusal side of the aligner tray, toward the second side lower edge of the aligner tray. The second open loop is typically bent to form approximately a right angle portion 72 configured to engage the second side lower edge of the aligner tray, and the wire continues toward the occlusal side of the aligner tray, forming a second occlusal portion 74 configured to extend across the occlusal side of the aligner tray, with the wire being bent to form approximately a right angle portion 76 extending away from the occlusal side of the aligner tray, and typically bent to form approximately a right angle portion 78 configured to engage the first side lower edge of the aligner tray at a second end 80 of the wire.

In another presently preferred embodiment illustrated in FIG. 4, the one or more clip members 82 are formed from a single wire 84 formed in a first open loop 86 at a first end 88 at a first lingual inter-tooth location 90 of the aligner tray at a lingual side 92 of the aligner tray, continuing to a distal middle portion 94 crossing the occlusal surface of the aligner tray to a labial side 96 of the aligner tray and forming a second open loop 98 at a first labial inter-tooth location 100 of the aligner tray. The first and second open loops and distal middle portion form a distal spring clip portion 102 with the first and second open loops gripping the edges of the aligner tray, the wire continuing to form a labial middle connecting and mounting surface portion 104 then progressing mesially along the labial-occlusal side of the aligner tray 106 to a second labial inter-tooth location 108 of the aligner tray and forming a third open loop 110 at the second labial inter-tooth location of the aligner tray, a mesial middle portion 112 crossing the occlusal surface of the aligner tray to the lingual side of the aligner tray and forming a fourth open loop 114 at a second lingual inter-tooth location 116 of the aligner tray, the third and fourth open loops and mesial middle portion forming a mesial spring clip 118 with the third and fourth open loops gripping the aligner tray.

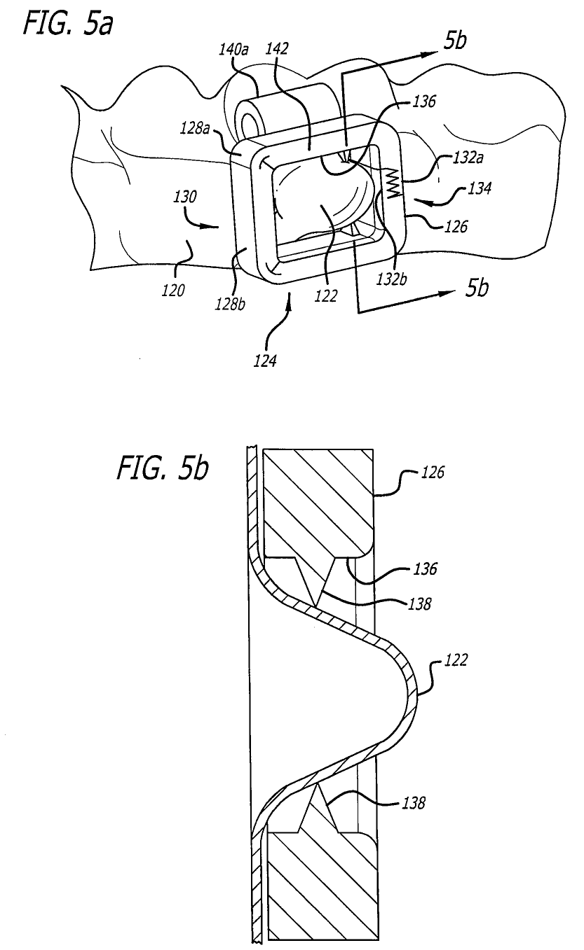

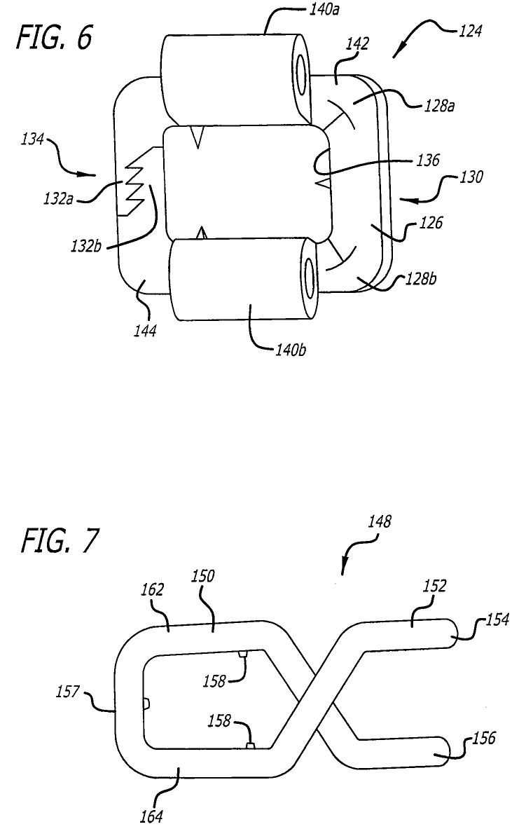

Referring to FIGS. 5a, 5b and 6, in another embodiment, where the aligner tray includes a side portion 120 with a protrusion 122, the one or more clip members 124 includes a clamping member 126 with a living hinges 128a, 128b at a first side 130 of the clamping member and a pair of removably clasping ends 132a, 132b at an opposing side 134 of the clamping member. The clamping member may be made of plastic, for example. The clamping member has a radially inwardly directed surface 136 including a plurality of prongs 138 directed radially inwardly for gripping the protrusion of the aligner tray. The clamping member typically includes a first tubular member 140a attached to an upper connecting arm portion 142 and, as is illustrated in FIG. 6, may also include a second tubular member 140b attached to a lower connecting arm portion 144 of the clamping member between the first portion and the opposing second portion.

In another embodiment illustrated in FIG. 7, where the aligner tray includes a side portion with a protrusion, the clip member 148 can be formed as a spring clip 150 formed of an elongated member 152 having first and second end portions 154, 156 and having spring properties. The elongated member is typically formed in a loop such that the first and second end portions overlap, and include a plurality of prongs 158 that are directed radially inwardly for gripping the protrusion of the aligner tray. The elongated member typically may also include a tubular member (not shown) attached to an upper connecting arm portion 162 or a lower connecting arm portion 164 of the elongated member between the first and second end portions.

The one or more clip members are typically formed of metal or plastic, and include a first lingual portion typically having a first retention member configured to engage the lingual edge of the aligner tray, a second labial portion having a second retention member configured to engage the labial edge of the aligner tray, and an occlusal portion connecting the first lingual portion and the second labial portion. The one or more clip members may advantageously include first and second parts that are configured to be detachably connected together, and that are configured to attach to the aligner tray, such as by penetrating the aligner tray, by mounting to a specified substrate surface molded into the aligner tray, or by engaging edges of the aligner tray. Alternatively, such first and second parts may also be permanently connected together, will be further explained below.

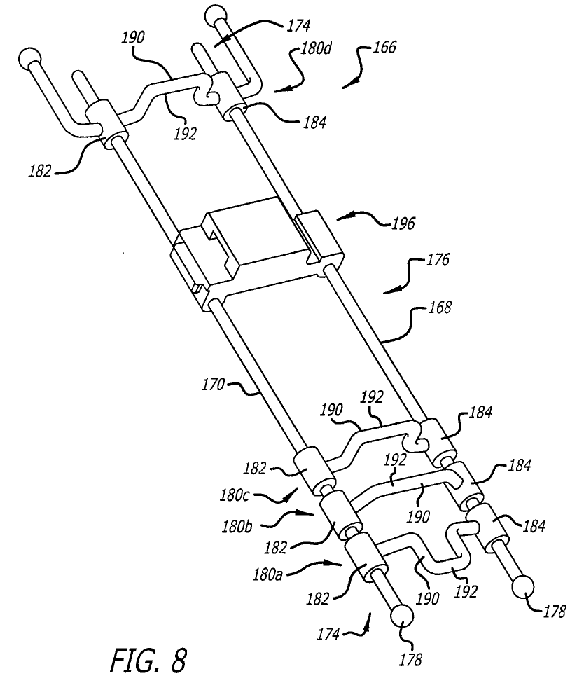

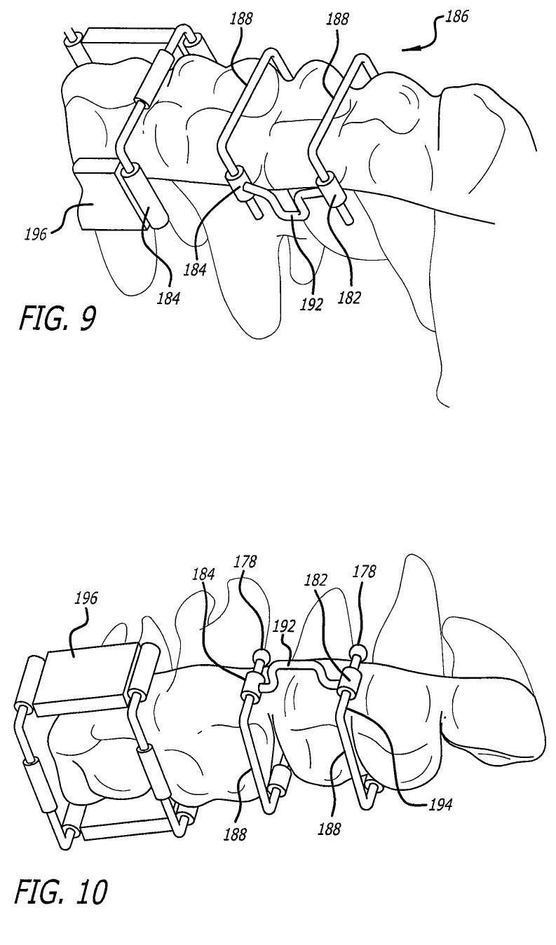

For example, in one presently preferred embodiment illustrated in FIGS. 8-10, the one or more clip members 166 are formed from first and second substantially parallel and spaced apart elongated members 168, 170 each having a first end 172 and a second end 174, and a middle portion 176 therebetween, with a stop member 178, such as a ball shaped stop member, at the first end. The first and second elongated members are slidably connected together by at least one connector member 180a, 180b, 180c, 180d having opposing first and second tubular ends 182, 184 configured to slidably receive the first and second elongated members, respectively, with the first and second ends of the elongated members extending at substantially a right angle in the same direction from the middle portion of the elongated members so as to form a “U-shaped” clip 186, with a “U-shaped” portion in the middle 188. The one or more connector members also preferably include a middle portion 190, which may be formed as a straight wire or a bent wire, or may be formed to have a U-shaped bend 192 configured to be crushed to fix a desired distance between the first and second elongated members. The second ends of the elongated members may be bent to form a hook 194, so that the stop members at the first end and the hooks at the second ends can engage the edges of an aligner tray. In a presently preferred aspect, the mounting portion typically includes at least one flat mounting plate 196 slidably connected between the first and second elongated members. Alternatively, the first and second elongated members may be permanently connected together, and the mounting portion may also be permanently mounted between the first and second elongated members, such as by soldering, welding, or crimping, for example, in a desired configuration.

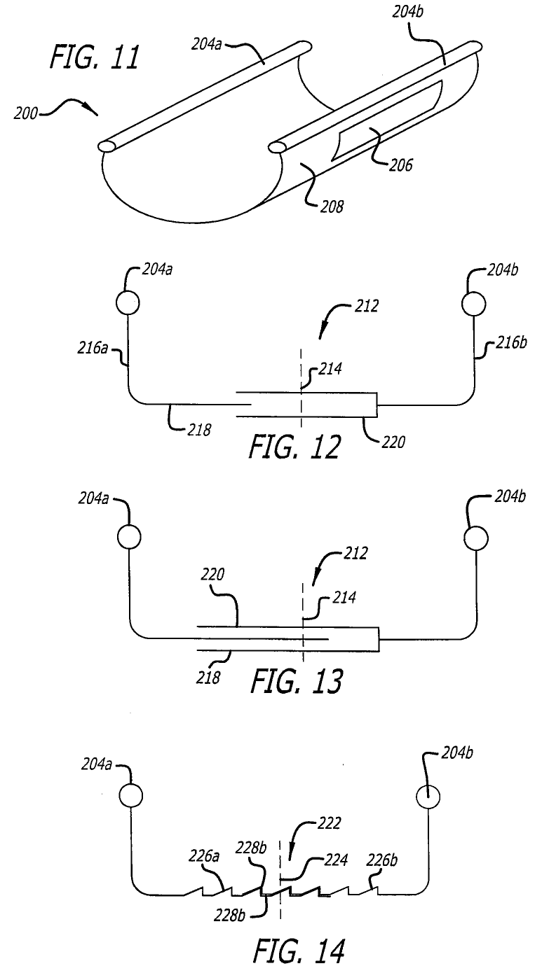

In another presently preferred embodiment illustrated in FIG. 11, a U-shaped clip 200 is configured to be attached over the occlusal side of the aligner tray. The U-shaped clip has gingival mesial-distal cylindrical edges 204a, 204b which provide a mechanical retention configuration permitting attachment of connectors for orthodontic appliances. The U-shaped clip may additionally have at least one mounting surface area 206 on a lingual side 208 of the clip for mounting of lingual attachments, including but not limited to cleats, buttons, sheaths, via welding, solder, bonding adhesive, mechanical connections, such as crimping, screws, molded in features, for example, and the like. One or more mounting surface areas may also be provided on the labial side of the U-shaped clip for similar mounting of labial attachments, similar to the mounting of attachments on the lingual side.

In another presently preferred version shown in FIGS. 12 and 13, the U-shaped clip has an approximate midline 212 and a longitudinal axis 214, and the U-shaped clip includes first and second halves 216a, 216b slidably joined together along the approximate midline and the longitudinal axis. The first half includes a male end 218 and the second half includes a female longitudinal slot 220, with the male end configured to be received in the female longitudinal slot. The distance between the lingual and labial sides of the U-shaped clip is thus adjustable by sliding of the first and second halves with respect to each other, and crimping the female longitudinal slot over the male end to lock the two halves of the U-shaped clip in place. The U-shaped clip can be sized on a “Stone mold” and the pieces can be crimped together to join the two halves in a single unit.

In another presently preferred version shown in FIG. 14, the U-shaped clip has an approximate midline 222 and a longitudinal axis 224, and the U-shaped clip includes first and second halves 226a, 226b with cooperating, interlocking indentations 228a, 228b configured to be adjustable by sliding of the first and second halves with respect to each other, and crimping the cooperating, interlocking indentations to lock the two halves of the U-shaped clip in place. The U-shaped clip can be sized on a “Stone mold” and the pieces can be crimped together to join the two halves in a single unit.

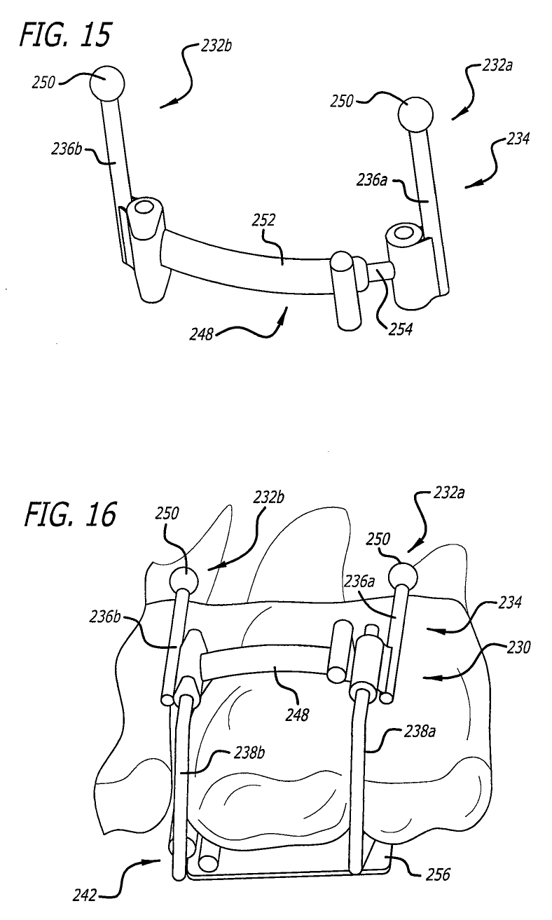

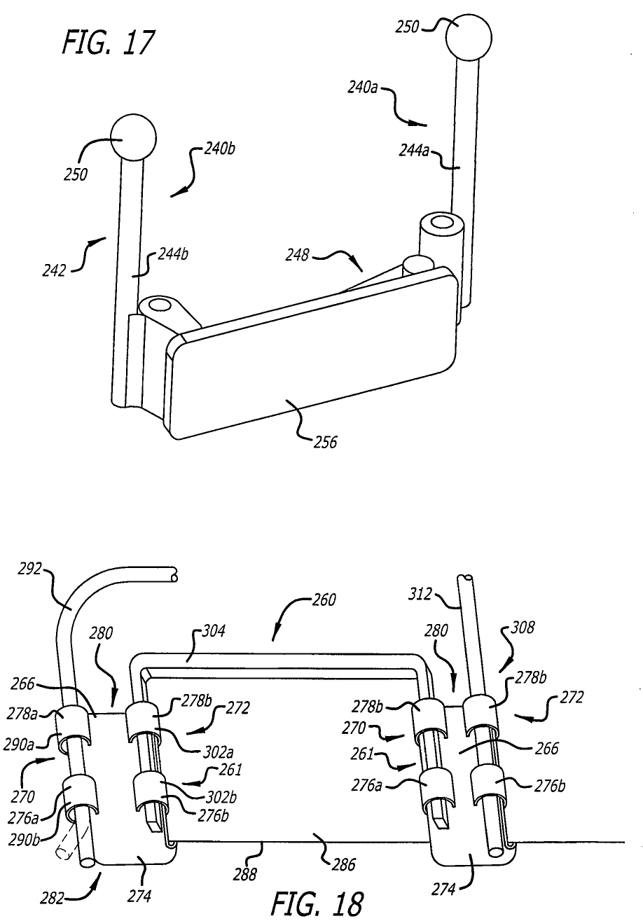

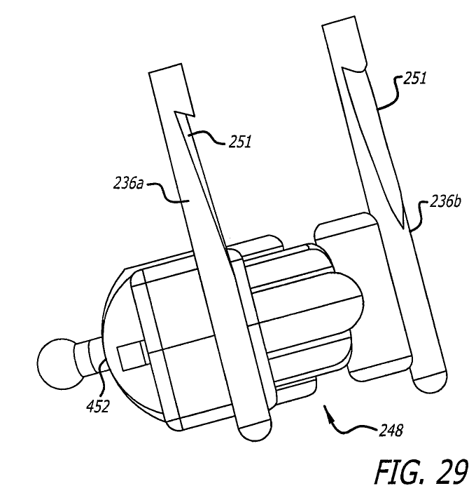

Referring to FIGS. 15-17, in another presently preferred embodiment, the one or more mounting clips include a clip member 230 having first and second retention members 232a, 232b formed by a first pair 234 of first and second shafts 236a, 236b connected by an occlusal connecting and mounting portion 238a, 238b and third and fourth retention members 240a, 240b formed by a second pair 242 of first and second shafts 244a, 244b connected by the occlusal connecting and mounting portion. The occlusal connecting and mounting portions can be occlusal spring clips, or can be occlusal rigid members for aligner trays that can be compressed slightly and act as a spring for retaining the occlusal connecting and mounting portions. The first and second pairs of first and second shafts are advantageously connected to the second pair of first and second shafts on at least one of the lingual and labial sides by a telescoping member 248, which can be crushed to fix the position of the first and second pairs of first and second shafts relative to each other. The first and second shafts terminate in a configuration that fits over the edge of the aligner tray to retain the mounting clip on the aligner tray. The first and second shafts of the first and second pairs of first and second shafts typically each terminate in a ball end 250 configured to fit over the edge of the aligner tray. However, as is illustrated in FIGS. 27 and 28, the first and second shafts of the first and second pairs of first and second shafts may each terminate in a hook end configured to fit over the edge of the aligner tray, or as is illustrated in FIG. 29, the first and second shafts may each terminate in a notched end configured to fit over the edge of the aligner tray, such as a “D-notch” end 251, for example. Alternatively, the configurations of the termination of the first and second shafts can be different from one another, being either a ball end or a hook end or a D-notch end, or other similar configurations, as desired. The telescoping member typically includes a sleeve member 252, such as a tubular sleeve member, for example, connected to one of the first and second shafts and a rod member 254 connected to the other of the first and second shafts, the rod member being slidably disposed in the tubular sleeve member. An additional mounting attachment, allowing the connection of one or more additional orthodontic connectors to the mounting clip, may be secured to the sleeve member. As is illustrated in FIGS. 16 and 17, a flat mounting plate 256 optionally may also be mounted to the tubular sleeve member, such as by soldering or welding, for example. Alternatively, as is illustrated in FIG. 29, a mounting wire 452 optionally may be mounted to the sleeve member, such as by soldering or welding, for example, allowing the connection of one or more additional orthodontic connectors to the mounting clip. Such mounting attachments may be provided on the sleeve members on the lingual and labial sides of the mounting clip, and may be the same or different.

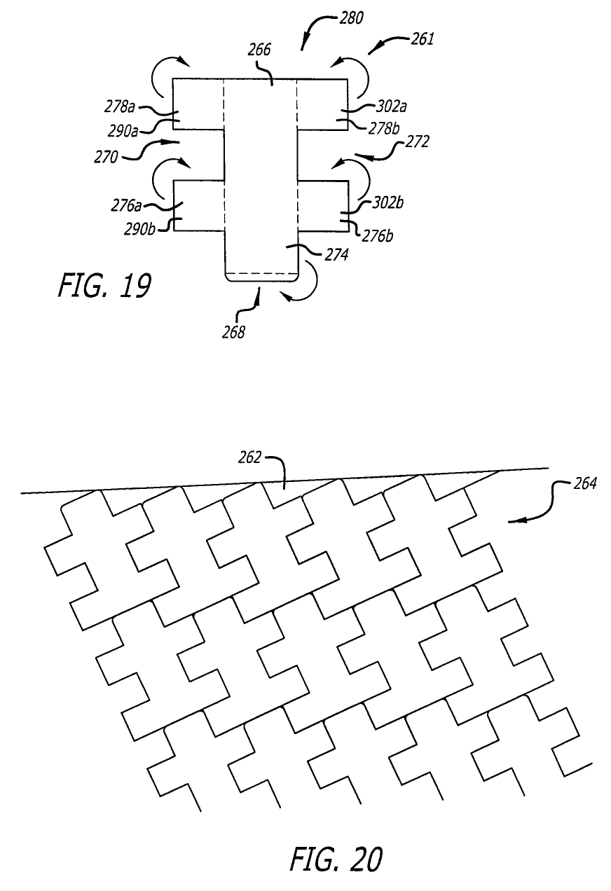

With reference to FIGS. 18-20, in another presently preferred embodiment, one or more clip members 260 may be formed from sheet metal, including a plurality of plate members 261 typically cut from a piece of flat sheet metal 262 in a flat pattern 264. The plate members each typically have a rectangular main body portion 266 having a narrow gingival side 268, a distal wide side 270, and a mesial wide side 272, with a gingival hook portion 274 formed extending from the narrow gingival side, two gingival side arm portions 276a, 276b adjacent to the gingival hook portion extending outwardly distally and mesially from the gingival side of the main body portion, and two occlusal side arm portions 278a, 278b extending outwardly distally and mesially from the occlusal narrow end 280 of the main body portion. A distal clip 282 is located at a distal inter-tooth location on the labial side of an aligner tray 286, oriented with the gingival hook portion toward the gingival edge 288 of the aligner tray. A distal pair 290a, 290b of the occlusal and gingival side arm portions are typically crimped (or spot welded) to retain a distal occlusal wire 292 (or a back bend wire on the gingival side of bracket) configured to cross the occlusal side of the aligner tray to a corresponding and substantially identical distal clip (not shown) on the lingual side of the aligner tray. The gingival hook portions of the distal clips on the labial and lingual sides of the aligner tray are typically bent to hook onto the gingival edge of the aligner tray. A mesial pair 302a, 302b of the occlusal and gingival side arm portions are also typically crimped (or spot welded) to retain a middle connecting wire 304 configured to be positioned on the labial side of the aligner tray, progressing mesially along the labial-occlusal side of the aligner tray to a corresponding mesial clip 308 located at a mesial inter-tooth location of the aligner tray on the labial side of the aligner tray, and similarly having a mesial occlusal wire 312 configured to cross the occlusal side of the aligner tray to a corresponding substantially identical clip (not shown) on the lingual side of the aligner tray. Each of the mesial sheet metal clips are oriented with the gingival hook portions toward the gingival edge of the aligner tray, with a mesial pair of the occlusal and gingival side arm portions of each of the mesial pair of sheet metal clips retaining the mesial occlusal wire connecting the mesial sheet metal clips on the labial and lingual sides of the aligner tray, and with the gingival hook portions bent to hook onto the gingival edge of the aligner tray. A middle connecting wire (not shown) substantially identical to the middle connecting wire on the labial side of the aligner tray is also connected between the occlusal and gingival mesial side arm portions of the distal sheet metal clip on the lingual side of the aligner tray (not shown) and the occlusal and gingival distal side arm portions of the mesial sheet metal clip on the lingual side of the aligner tray (not shown).

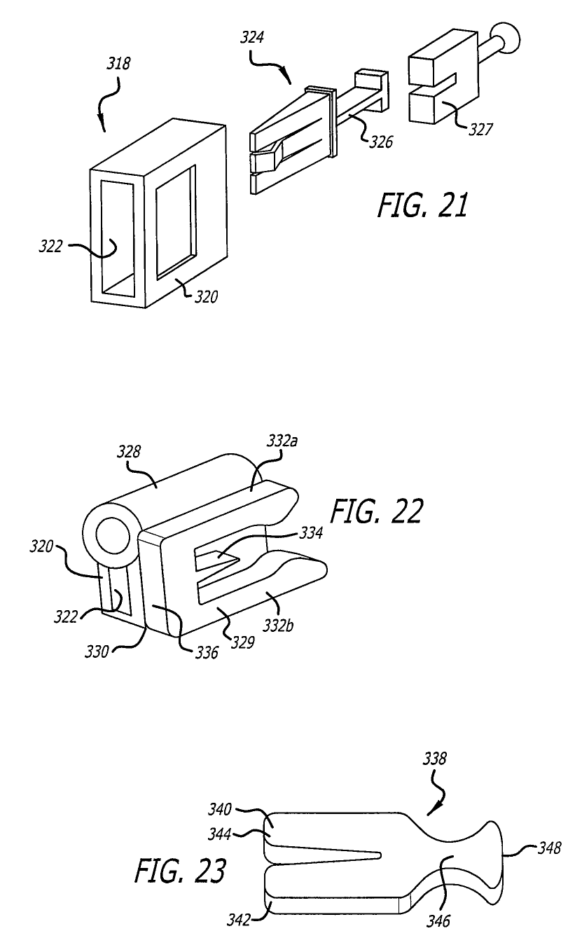

In another presently preferred aspect illustrated in FIGS. 21-23, the one or more clip members may include a mounting portion 318 on the one or more clip members configured to secure an orthodontic appliance to the one or more clip members. The mounting portion may, for example, be formed as a rectangular tubular member 320 with a slot 322 for receiving a spring clip 324 with a post 326 for receiving an orthodontic bracket screw or clamp mounting device 327. The mounting portion may alternatively, for example, also include a forked mounting member 329 mounted to a side portion 330 of the rectangular tubular piece, the forked mounting member having substantially parallel first and second arms 332a, 332b, and a third central arm 334 disposed between the first and second arms, with the first, second and third central arms extending from a first end 336 of the forked mounting member. Referring to FIG. 22, the mounting portion may also, for example, further include a forked clip-on member 338 mounted to the forked mounting member, with the forked clip-on member having substantially parallel first and second arms 340, 342 extending at a first end 344 of the forked clip-on member, and a center post 346 extending at an opposing end 348 of the forked clip-on member.

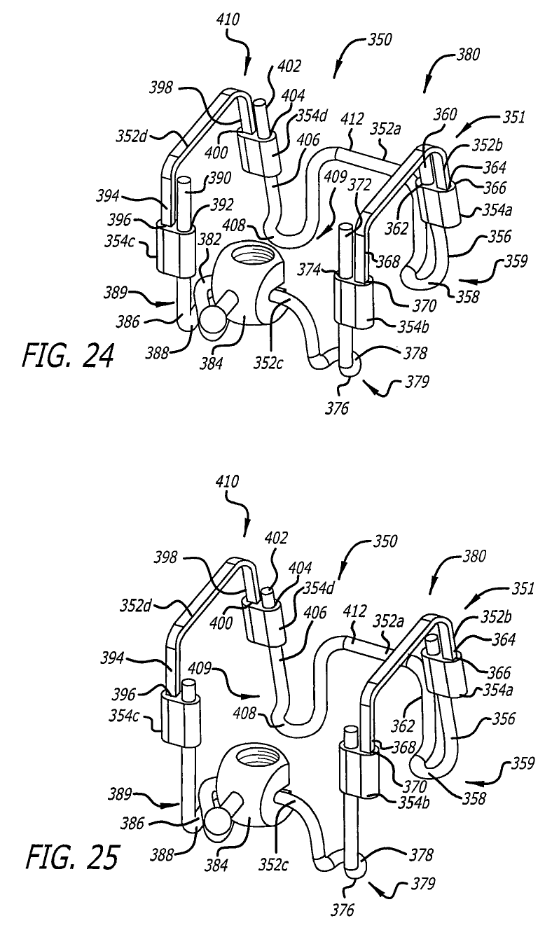

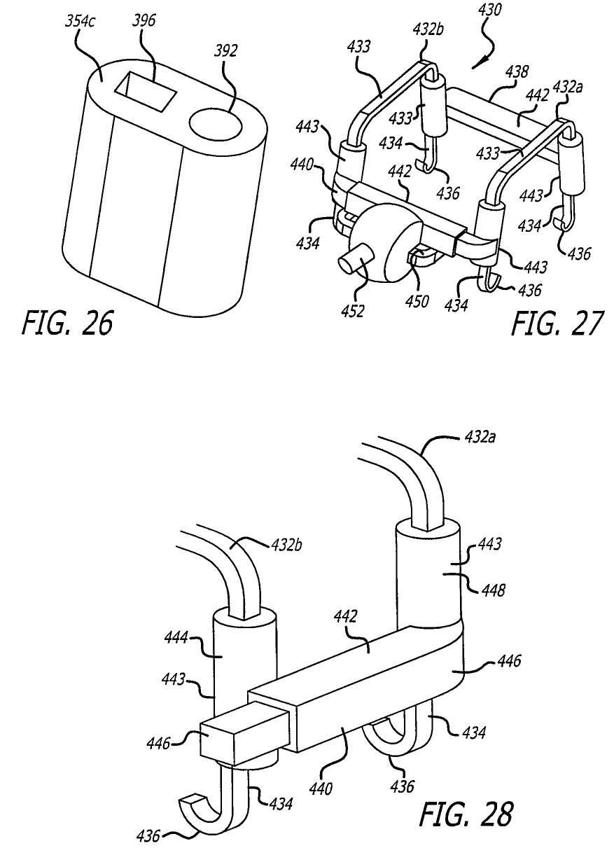

Referring to FIGS. 24-26, the one or more mounting clips include a clip member 350 with a wire frame 351 formed from one or more wires, such as a plurality of wire portions, which can include a lingual wire portion 352a, a distal occlusal surface spring wire portion 352b, a labial wire portion 352c, and a mesial occlusal surface spring wire portion 352d, with the wire portions adjustably connected together by coupling members 354a, 354b, 354c, 354d. As is illustrated in FIGS. 24 and 25, the positions of the lingual and labial wire portions with respect to the occlusal surface spring wire portions can be moved by sliding the lingual and labial wire portions within the coupling members, as will be further described below. The lingual wire portion is typically bent to form a first open loop 356 with an end 358 of the first open loop bent to extend toward the labial wire portion to form a hook 359 for gripping the lingual edge of the aligner tray at a distal-lingual inter-tooth location of the aligner tray. A distal end 360 of the lingual wire portion is adjustably received in a first aperture 362 of the first coupling member 354a, and a lingual end 364 of the distal occlusal surface wire portion 352b is received in a second aperture 366 of the first coupling member 354a, to continue the wire frame from the first open loop, with the distal occlusal surface wire portion 352d extending across the occlusal side of the aligner tray to a labial side of the aligner tray. The labial end 368 of the distal occlusal surface wire portion 352b is received in a first aperture 370 of the second coupling member 354b. A distal end 372 of the labial wire portion 352c is adjustably received in a second aperture 374 of the second coupling member 354b, and the labial wire portion is typically bent to form a second open loop 376 with an end 378 of the second open loop bent to extend toward the lingual wire portion to form a hook 379 for gripping the labial edge of the aligner tray at a distal-labial inter-tooth location of the aligner tray. The first and second open loops and the distal occlusal surface portion form a distal spring clip portion 380, and the first and second open loops are preferably configured to grip the lingual and labial edges of the aligner tray. Alternatively, the distal occlusal surface spring wire portion 352b and distal clip portion can be formed of rigid material for aligner trays that can be compressed slightly and that will act as a spring for retaining the occlusal distal clip portion.

The labial wire portion 352c is configured to continue from the second open loop to form a labial middle connecting portion 382, to which a mounting attachment 384 may be secured, such as by crimping, soldering or welding, for example. The labial wire portion 352c is configured to continue mesially along the labial side of the aligner tray from the labial middle connecting portion, and is typically bent to form a third open loop 386 with an end 388 of the third open loop bent to extend toward the lingual wire portion to form a hook 389 for gripping the labial edge of the aligner tray at a mesial-labial inter-tooth location of the aligner tray. A mesial end 390 of the labial wire portion is adjustably received in a first aperture 392 of the third coupling member 354c, and a labial end 394 of the mesial occlusal surface wire portion 352d is received in a second aperture 396 of the third coupling member 354c, to continue the wire frame from the third open loop, with the mesial occlusal surface wire portion 352d extending across the occlusal side of the aligner tray to the lingual side of the aligner tray. The lingual end 398 of the mesial occlusal surface wire portion 352d is received in a first aperture 400 of the fourth coupling member 354d. A mesial end 402 of the lingual wire portion 352a is adjustably received in a second aperture 404 of the fourth coupling member 354d, and the lingual wire portion is typically bent to form a fourth open loop 406 with an end 408 of the fourth open loop bent to extend toward the labial wire portion to form a hook 409 for gripping the lingual edge of the aligner tray at a mesial-lingual inter-tooth location of the aligner tray. The third and fourth open loops and the mesial occlusal surface spring wire portion form a mesial clip portion 410, and the third and fourth open loops are preferably configured to grip the lingual and labial edges of the aligner tray. Alternatively, the mesial occlusal surface spring wire portion 352d and mesial clip portion can be formed of rigid material for aligner trays that can be compressed slightly and that will act as a spring for retaining the occlusal distal clip portion. The lingual wire portion 352a is configured to continue from the fourth open loop to form a lingual middle connecting portion 412, to which a mounting attachment may be secured, and continues distally along the lingual side of the aligner tray from the lingual middle connecting portion to the first open loop described above. Once the positions of the lingual and labial wire portions have been adjusted, any excess projection of the occlusal ends of the lingual and labial wire portions, such as in FIG. 24, may be trimmed as desired.

Referring to FIGS. 27-28, in another presently preferred embodiment, the one or more mounting clips include a clip member 430 having occlusal connecting and mounting clip members 432a, 432b, typically formed of metal with spring properties, having middle spring clip occlusal portions 433 and gingivally directed end portions 434 that may each terminate in a gingival hook end 436 configured to fit over the lingual and labial edges of the aligner tray to retain the occlusal connecting and mounting clip members on the aligner tray. Alternatively, the occlusal connecting and mounting clip members may be formed of rigid material for aligner trays that can be compressed slightly and act as a spring for retaining the occlusal connecting and mounting portions. The gingival ends of the occlusal connecting and mounting clip members may also alternatively each terminate in a ball end or a notched end configured to fit over the edge of the aligner tray, such as a “D-notch” end 251, for example, as is illustrated in FIG. 29, or the configurations of the gingival ends of the occlusal connecting and mounting clip members can be different from one another, being either a ball end or a hook end or a notched end, or other similar configurations, as desired. The lingual sides of the occlusal connecting and mounting clip members are connected by a telescoping member 438, and the labial sides of the occlusal connecting and mounting clip members are connected by a telescoping member 440, each of the telescoping members having coupling portions 443 with an interior channel receiving and retaining the gingival end portions of the occlusal connecting and mounting clip members.

Each of the telescoping members typically includes a hollow sleeve member 442 connected to one of the occlusal connecting and mounting clip members by a coupling member 444, and a rod member 446 connected to the other of the occlusal connecting and mounting clip members by a coupling member 448, with the rod member being slidably disposed in the tubular sleeve member. A desired position of the occlusal connecting and mounting clip members relative to each other can be fixed by crushing, soldering or welding the telescoping members to the rod members, respectively, for example. An additional mounting attachment, such as a mounting wire 450, for example, optionally may be secured to the sleeve member, such as by soldering or welding, for example, allowing the connection of one or more additional orthodontic connectors 452 to the mounting clip. Such a mounting attachment may be provided on the sleeve members on the lingual and labial sides of the mounting clip, and may be the same or different.

In the foregoing embodiments, the mounting clips and clip members may be formed of metal, such as steel or a shape memory metal alloy, such as a nickel-titanium alloy, for example, or a polymer, including a shape memory polymer, for example, although other similar materials may also be suitable for making the mounting clips and clip members of the invention. It will be apparent from the foregoing that while particular forms of the invention have been illustrated and described, various modifications can be made without departing from the spirit and scope of the invention. Accordingly, it is not intended that the invention be limited, except as by the appended claims.

We claim:

1. A mounting clip for attaching an orthodontic appliance to an orthodontic aligner tray for correction of moderate to severe orthodontic malocclusions, the aligner tray having a lingual side, a labial side, an occlusal side, and gingival lingual and labial edges, comprising:
at least one clip member configured to be removably attached to at least one of said lingual, occlusal, and labial sides of said aligner tray; and
at least one mounting portion on said at least one clip member configured to secure an orthodontic appliance to said at least one clip member.

2. The mounting clip of claim 1, wherein said at least one clip member comprises a first lingual portion having a first retention member configured to engage the lingual edge of the aligner tray, a second labial portion having a second retention member configured to engage the labial edge of the aligner tray, and an occlusal portion connecting said first lingual portion and said second labial portion.

3. The mounting clip of claim 2, wherein said at least one clip member comprises first and second parts that are configured to be detachably connected together.

4. The mounting clip of claim 3, wherein said first part of said at least one clip member is attached to the aligner tray, and the second part of said at least one clip member is attached to the orthodontic appliance.

5. The mounting clip of claim 2, wherein said first retention member of said at least one clip member comprises a first pair of first and second shafts connected by an occlusal spring clip, and said second retention member of said at least one clip member comprises a second pair of first and second shafts connected by an occlusal spring clip, said first pair of first and second shafts being connected to said second pair of first and second shafts on at least one of said lingual and labial sides by a telescoping member which can be crushed to fix the position of said first and second pairs of first and second shafts relative to each other.

6. The mounting clip of claim 5, wherein said first and second shafts of said first and second pairs of first and second shafts each terminate in a ball end configured to fit over the edge of the aligner tray.

7. The mounting clip of claim 5, wherein said telescoping member comprises a tubular sleeve member connected to one of said first and second shafts, and a rod member connected to the other of said first and second shafts, said rod member being slidably disposed in said tubular sleeve member, and further comprising a flat mounting plate mounted to said tubular sleeve member.

8. The mounting clip of claim 1, wherein said at least one clip member comprises a U-shaped clip configured to be attached over the occlusal side of the aligner tray, the U-shaped clip having first and second gingival mesial-distal cylindrical edges and providing a mechanical retention configuration permitting attachment of an orthodontic connector to the mounting clip.

9. The mounting clip of claim 8, wherein said U-shaped clip comprises at least one mounting surface area on a lingual side of the clip for mounting of lingual attachments.

10. The mounting clip of claim 8, wherein said U-shaped clip comprises at least one mounting surface area on a labial side for mounting of labial attachments.

11. The mounting clip of claim 8, wherein said U-shaped clip has an approximate midline and a longitudinal axis, and said U-shaped clip comprises first and second halves slidably joined together along said approximate midline and said longitudinal axis, said first half having a male end and said second half having a female longitudinal slot, said male end configured to be received in said female longitudinal slot, and the distance between the lingual and labial sides of said U-shaped clip being adjustable by sliding of said first and second halves with respect to each other and crimping said female longitudinal slot over said male end to lock the two halves of said U-shaped clip in place.

12. The mounting clip of claim 8, wherein said U-shaped clip has an approximate midline and a longitudinal axis, and said U-shaped clip comprises first and second halves with cooperating, interlocking indentations configured to be adjustable by sliding of said first and second halves with respect to each other and crimping said cooperating, interlocking indentations to lock the two halves of said U-shaped clip in place.

13. The mounting clip of claim 1, wherein said at least one clip member comprises first and second substantially parallel and spaced apart elongated members each having a first end and a second end and a middle portion therebetween, with a stop member at the first end, said first and second elongated members being slidably connected together by at least one connector member having opposing first and second tubular ends configured to slidably receive said first and second elongated members, respectively, with said first and second ends of said elongated members extending at substantially a right angle in the same direction from said middle portion of said elongated members.

14. The mounting clip of claim 13, wherein said elongated members form a U-shaped clip.

15. The mounting clip of claim 13, wherein said at least one connector member includes a middle portion formed to have a U-shaped bend configured to be crushed to adjust the distance between said first and second elongated members.

16. The mounting clip of claim 13, wherein said second ends of said elongated members are bent to form a hook.

17. The mounting clip of claim 13, wherein said at least one mounting portion comprises at least one flat mounting plate connected between said first and second elongated members.

18. The mounting clip of claim 1, wherein said at least one clip member comprises a wire clip formed from at least one wire, said at least one wire being formed in a first open loop at a distal-lingual inter-tooth location of the aligner tray, said at least one wire configured to continue from said first open loop in a distal occlusal surface portion across the occlusal side of the aligner tray to a labial side of the aligner tray and formed in a second open loop at a distal-labial inter-tooth location of the aligner tray, the first and second open loops and said distal occlusal surface portion forming a distal spring clip portion, with the first and second open loops configured to grip the lingual and labial edges of the aligner tray, said at least one wire being configured to continue from said second open loop to form a labial middle connecting portion, said at least one wire being configured to continue mesially along the labial side of the aligner tray and formed in a third open loop at a mesial-labial inter-tooth location of the aligner tray, said at least one wire being configured to continue from said third open loop in a mesial occlusal surface portion across the occlusal side of the aligner tray to the lingual side of the aligner tray and formed in a fourth open loop at a mesial-lingual inter-tooth location of the aligner tray, the third and fourth open loops and said mesial occlusal surface portion forming a mesial spring clip portion with the third and fourth open loops configured to grip the lingual and labial edges of the aligner tray.

19. The mounting clip of claim 1, wherein said at least one clip member comprises a sheet metal clip formed from flat sheet metal in a flat pattern, said sheet metal clip having a rectangular main body portion having a narrow gingival side, a distal wide side, and a mesial wide side, a gingival hook portion extending from the narrow gingival side, two gingival side arm portions adjacent to the gingival hook portion extending outwardly distally and mesially from the gingival side of the main body portion, and two occlusal side arm portions extending outwardly distally and mesially from the occlusal narrow end of the main body portion.

20. The mounting clip of claim 19, wherein said at least one clip member comprises a distal pair of sheet metal clips located at a distal inter-tooth location of the aligner tray, and a mesial pair of sheet metal clips located at a mesial inter-tooth location of the aligner tray, said distal pair of sheet metal clips including a distal labial sheet metal clip configured to be positioned on the labial side of the aligner and a distal lingual sheet metal clip configured to be positioned on the lingual side of the aligner, each of said distal pair of sheet metal clips being oriented with the gingival hook portion toward the gingival edge of the aligner tray, a distal pair of said occlusal and gingival side arm portions of each of said distal pair of sheet metal clips retaining a distal occlusal wire configured to cross the occlusal side of the aligner tray and connecting said distal pair of sheet metal clips, and the gingival hook portions being bent to hook onto the gingival edge of the aligner tray, said mesial pair of sheet metal clips including a mesial labial sheet metal clip configured to be positioned on the labial side of the aligner and a mesial lingual sheet metal clip configured to be positioned on the lingual side of the aligner, each of said mesial pair of sheet metal clips being oriented with the gingival hook portion toward the gingival edge of the aligner tray, a mesial pair of the occlusal and gingival side arm portions of each of said mesial pair of sheet metal clips retaining a mesial occlusal wire configured to cross the occlusal side of the aligner tray and connecting said mesial pair of sheet metal clips, and the gingival hook portions being bent to hook onto the gingival edge of the aligner tray, and a pair of labial and lingual middle connecting wires being connected between said occlusal and gingival mesial side arm portions of said distal pair of sheet metal clips and said occlusal and gingival distal side arm portions of said mesial pair of sheet metal clips.

21. The mounting clip of claim 1, wherein said at least one mounting portion comprises a rectangular tubular member having a slotted portion configured to receive a spring clip having a post for mounting of an orthodontic appliance.

22. The mounting clip of claim 21, further comprising a forked member mounted to a side portion of said rectangular tubular member, said forked member having substantially parallel first and second arms extending from a first end of the forked member, and a center post extending from a second end of the forked member.

23. The mounting clip of claim 21, further comprising a forked member mounted to a side portion of said rectangular tubular member, said forked member having substantially parallel first and second arms and a third central arm disposed between said first and second arms, said first, second and third central arms extending from a first end of the forked member.

24. The mounting clip of claim 1, wherein said at least one clip member further comprises a plug member attached to said at least one clip member, and said at least one mounting portion comprises a spring clip having radially inwardly directed gripping teeth configured to grip said plug member.

25. The mounting clip of claim 1, wherein said aligner tray includes a side portion with a protrusion, and wherein said at least one clip member comprises a clamping member with a living hinge at a first portion of the clamping member and a pair of removably clasping ends at an opposing second portion of the clamping member, said clamping member having a radially inward surface including a plurality of prongs directed radially inwardly for gripping said protrusion of said aligner tray.

26. The mounting clip of claim 25, wherein said clamping member comprises a tube member attached to said clamping member between said first portion and said opposing second portion.

27. The mounting clip of claim 1, wherein said aligner tray includes a side portion with a protrusion, and wherein said at least one clip member comprises a spring clip formed of an elongated member having first and second end portions and having spring properties, said elongated member being formed in a loop such that said first and second end portions overlap, and said spring clip has a radially inward surface including a plurality of prongs directed radially inwardly for gripping said protrusion of said aligner tray.

28. The mounting clip of claim 1, wherein said at least one clip member is formed from metal.

29. The mounting clip of claim 1, wherein said at least one clip member is formed from a shape memory metal alloy.

30. The mounting clip of claim 1, wherein said at least one clip member is formed from a nickel-titanium alloy.

31. The mounting clip of claim 1, wherein said at least one clip member is formed from a polymer.

32. The mounting clip of claim 1, wherein said at least one clip member is formed from a shape memory polymer.

33. The mounting clip of claim 2, wherein said at least one clip member comprises first and second parts that are permanently connected together.

34. The mounting clip of claim 2, wherein said first retention member of said at least one clip member comprises a first pair of first and second shafts connected by an occlusal rigid member, and said second retention member of said at least one clip member comprises a second pair of first and second shafts connected by an occlusal rigid member, said first pair of first and second shafts being connected to said second pair of first and second shafts on at least one of said lingual and labial sides by a telescoping member which can be crushed to fix the position of said first and second pairs of first and second shafts relative to each other.

35. The mounting clip of claim 5, wherein said first and second shafts of said first and second pairs of first and second shafts each terminate in a hook end configured to fit over the edge of the aligner tray.

36. The mounting clip of claim 5, wherein said first and second shafts of said first and second pairs of first and second shafts each terminate in a notched end configured to fit over the edge of the aligner tray.

37. The mounting clip of claim 5, wherein said first and second shafts of said first and second pairs of first and second shafts each terminate in a configuration that fits over the edge of the aligner tray to retain the mounting clip on the aligner tray.

38. The mounting clip of claim 5, wherein said telescoping member comprises a sleeve member connected to one of said first and second shafts, and a rod member connected to the other of said first and second shafts, said rod member being slidably disposed in said sleeve member, and further comprising a mounting wire mounted to said sleeve member.

39. The mounting clip of claim 5, wherein said telescoping member comprises a sleeve member connected to one of said first and second shafts, and a rod member connected to the other of said first and second shafts, said rod member being slidably disposed in said sleeve member, and further comprising a mounting attachment secured to said sleeve member to permit connection of an orthodontic connector to the mounting clip.

40. The mounting clip of claim 1, wherein said at least one clip member comprises a lingual portion having first and second retention members, said first and second retention members being configured to engage the lingual edge of the aligner tray, and said first and second retention members being connected by a first middle connecting and mounting portion, a labial portion having a third and fourth retention members, said third and fourth retention members being configured to engage the labial edge of the aligner tray, and said third and fourth retention members being connected by a second middle connecting and mounting portion, and first and second occlusal portions connecting said lingual portion and said labial portion.

41. The mounting clip of claim 40, wherein said first and second retention members of said lingual portion comprise a lingual wire connected between said first and second occlusal portions, said lingual wire being formed in a first open loop connected to said first occlusal portion at a first lingual inter-tooth location of the aligner tray, said wire continuing from said first open loop to form said first middle connecting and mounting portion, said wire continuing from said first middle connecting and mounting portion to form a second open loop, said second open loop being connected to said second occlusal portion at a second lingual inter-tooth location of the aligner tray, and wherein said third and fourth retention members of said labial portion comprise a labial wire connected between said first and second occlusal portions, said labial wire being formed in a third open loop connected to said first occlusal portion at a third labial inter-tooth location of the aligner tray, said wire continuing from said third open loop to form said second middle connecting and mounting portion, said wire continuing from said second middle connecting and mounting portion to form a fourth open loop, said fourth open loop being connected to said second occlusal portion at a second labial inter-tooth location of the aligner tray.

42. The mounting clip of claim 41, wherein at least one of said first and second middle connecting and mounting portions further comprises a flat mounting plate.

43. The mounting clip of claim 13, wherein said at least one mounting portion comprises at least one straight wire connected between said first and second elongated members.

44. The mounting clip of claim 13, wherein said at least one mounting portion comprises at least one bent wire connected between said first and second elongated members.
